(19) United States
(12) Patent Application Publication
(10) Pub. No.: US 2005/0174952 A1
(43) Pub. Date: Aug. 11, 2005

(54) Method and system for resource management in a communication network

(76) Inventors: Eero Sillasto, Helsinki (FI); Pedro Serna, Santander (ES)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/085,623

(22) Filed: Mar. 22, 2005

Related U.S. Application Data
(63) Continuation of application No. PCT/FI02/00758, filed on Sep. 23, 2002.

(51) Int. Cl. H04Q 7/00; H04L 12/28

(52) U.S. Cl. 370/278; 370/395.21

(57) ABSTRACT

The present invention describes a method and system for reserving transport resources in a communication network, wherein transport resources have to be reserved for data transmissions. The present invention can be used in any mobile or wireline network if there exists some resources that should be reserved and the reservation takes time. The solution for reserving resources described in the present invention can be used to trigger resource reservation and/or a setup of a resource, if the transport protocol session setup messages can be distinguished from other messages. In the preferred embodiment of the present invention, the need of resources is predicted by monitoring the TCP packets. The session level setup messages indicate the forthcoming arrival of data and trigger the resource allocation.

This is a Continuation of International Application No. PCT/FI2002/000758 filed Sep. 23, 2002, which designated the U.S. and was published under PCT Article 21(2) in English.

### FIELD OF THE INVENTION

The present invention relates to telecommunication systems. In particular, the present invention relates to a novel and improved method and system for reserving transport resources in a communication network.

### BACKGROUND OF THE INVENTION

Non Real-Time (NRT) traffic is transmitted as packets over usually unreliable network. The network can be either a fixed or a wireless one. Because the network is unreliable and weak for congestion, special transport (and transaction) protocols have been designed. The most common protocol examples are the TCP (Transmission Control Protocol), and for mobile terminals, the WTP (Wireless Transaction Protocol). Both of them use the session concept. The transmission of user data may be performed only if both, server and client know that there is a session between them.

In telecommunication networks, a session is a series of interactions that occur during the span of a single connection between two communication endpoints. Typically, one endpoint requests a connection with another specified endpoint, and if that endpoint agrees the connection request, the endpoints take turns exchanging commands and data. The session begins when the connection is established at both ends and terminates when the connection is ended. A connection is maintained while the two endpoints are communicating back and forth in a conversation or session of some duration. Some connections and sessions last only long enough to send a message in one direction. However, other sessions may last longer, usually with one or both of the communicating parties able to terminate it. For Internet applications, each session is related to a particular port, a number that is associated with a particular upper layer application. Each transport or transaction protocol has its own messages, which can be distinguished from other packets.

Radio communication systems, such as mobile networks, have started to provide packet data services for the users in addition to circuit switched services in the last few years. A packet data service is typically a service in which information is transmitted within data packets. The sizes and lengths of the data packets may vary. Information is typically carried by means what are often referred to as packet data bearers. The transmission speed of a bearer is defined by a parameter referred to as bit rate. More particularly, bit rate defines the bit rate allocated for a user of the packet data services. For example, in the WCDMA (Wideband Code Division Multiple Access) based systems bit rate values such as 16, 32, 64, 128 and 384 kbits may be used.

The non real-time (NRT) packet services via an air interface are different from real-time (RT) services (i.e. circuit switched services). Packet data is bursty by its nature. The required bit rate can change rapidly from zero to hundreds of kilobits per second. Packet data tolerates longer delay times than circuit switched services. Therefore, the packet data traffic may be more readily controlled from a radio access network point of view. For example, in interactive services a user must get resources within a reasonable time, but in background type services data can be transmitted when free radio interface capacity can be allocated for the transmission.

In a WCDMA based system the applicable transport channels for packet data transfer are e.g. Dedicated Transport Channel (DCH) in uplink and downlink direction, Random Access Channel (RACH) in uplink direction, Forward Access Channel (FACH) in downlink direction, Common Packet Channel (CPCH) in uplink direction, High Speed Downlink Packet Access (HSDPA) in downlink direction, and Downlink Shared Channel (DSCH) in downlink direction.

In many telecommunication networks transport resources have to be reserved, allocated and/or setup beforehand. These telecommunication networks especially comprise wireless networks, e.g. the UTRAN (UMTS Terrestrial Radio Access Network), GERAN (Gsm Edge Radio Access Network), CDMA2000 (Code Division Multiple Access), and WLAN (Wireless Local Area Network). Naturally, there may exist also wireline networks in which some or all of the transport resources must be reserved.

The problem with the reservation of transport resources will now be made using the UTRAN as an exemplary telecommunication network and the Transmission Control Protocol (TCP) as the transport protocol. The setup messages of a session are small in size, e.g. the TCP/IP setup messages are order of 40 bytes with the IPv4 and 60 bytes with the IPv6. These setup messages are user plane traffic for the UTRAN, but as they are probably transmitted in the radio interface by means of common channel, they will probably not trigger the dedicated channel or shared channel allocation. The use of common channels means that no dedicated resources need to be reserved in the Iub interface so there is not any delay incurred due to the Iub connection setup.

The Iub interface is UTRAN specific interface between the RNC and BTS (or Node B). The Iub interface is described in more detail in the 3^{rd} Generation Partnership Project (3GPP) specifications 3GPP TS 25.425, 3GPP TS 25.426, 3GPP TS 25.427, and 3GPP TS 25.430-3GPP TS 25.435.

Once the session is setup the data transmission begins. On arrival of this data and based on the size of messages to be transmitted, the Radio Network Controller (RNC) can decide that the actual resources (e.g. based on common channels) are not enough and it will decide to allocate a dedicated or shared resource (for instance a DCH or DSCH in the UTRAN). In the UTRAN, this implies the setup of the Iub connection for the dedicated or shared resource before any data can actually be transmitted from the RNC to the Base Transceiver station (BTS). This setup takes time and therefore causes extra delay in the end-to-end transmission time, which the user of the NRT service experiences as degradation in her/his service.

FIG. 1 describes the signaling flow for the setup of a TCP connection when HyperText Transfer Protocol (HTTP) is used.
10. The TCP SYN message. The synchronization of the requesting end's (client) sequence number. This message has the SYN flag in the TCP header.
11. The TCP SYN message. The synchronization of the server end's sequence number. This message has the SYN flag in the TCP header.
12. The client acknowledges the server's SYN. This is a normal acknowledgement message. A possible HTTP request can be sent to the server within this message.
13. The server responds to the HTTP request by starting the data transmission and sends the first packet. The packet arrives at the RNC, which notices that the dedicated channel should be allocated.
14. The RNC has to setup the Iub resource. It sends a NBAP message to Node B: Radio Link Setup.
15. The Node B responds to the RNC: Radio Link Setup Response. There might be some signaling related to ATM links, e.g. AAL2 (not represented in FIG. 1).
16. A dedicated channel is allocated and the data packet is transmitted to the mobile terminal.

It is important to notice that based on the current solutions the Iub setup cannot happen before the first packets of the data session arrive if the small setup packets are transmitted on common channels. If all user plane traffic triggers dedicated channel (DCH or DCH/DSCH) allocation, the Iub setup occurs when the dedicated channel is allocated for the first setup message. However, the user experiences the Iub setup delay.

In general, there is an obvious need for a solution wherein resources, wireless of wireline, can be reserved for data transmissions before there is actual data to be forwarded. In prior-art solutions, resources are not reserved and/or setup until required.

### SUMMARY OF THE INVENTION

The present invention describes a method and system for reserving transport resources in a communication network. The communication network is e.g. the UMTS Terrestrial Radio Access Network (UTRAN), Internet Protocol Radio Access Network (IP-RAN), GSM EDGE Radio Access Network (GERAN), Code Division Multiple Access 2000 (CDMA2000), Wireless Local Area Network (WLAN) or any other communication network wherein transport resources have to be reserved for data transmissions. The system comprises a communication network, a plurality of nodes in connection with the communication network, the nodes comprising at least a sender node and receiver node.

A session is setup for a data transmission between the sender node and receiver node. The sender node is e.g. a mobile terminal and the receiver node e.g. a server providing data services for the mobile terminal. Necessary resources are reserved for the data transmission between the sender node and receiver node. When the resources are reserved they can be used for the data transmission between the sender node and receiver node.

In prior-art solutions, the reservation of needed resources is not done until there is data ready to be sent. In other words, actions are sequential. This causes unnecessary delay in the setup processes for data transmissions.

The present invention is based on the fact that transport protocol session setup messages can be distinguished from other messages. In the present invention, one or more identifiers are determined to be tracked. These identifiers are chosen to be the ones present in the setup messages of a session. When the predetermined identifier is then detected to be present in a session setup message, part or all of the transport resources needed for the data transmission are reserved between the sender and receiver beforehand. Reserving here means that actual resources may be reserved and/or that setup of a resource is done. The reservation of resources may comprise reservation of radio or wireline resources or both.

In one embodiment of the present invention, a timer is started when detecting the predetermined identifier(s) used in one or more setup messages of the session. When the timer expires, part or all of the resources needed for the data transmission are reserved.

In one embodiment of the present invention, the session is a non real-time data (NRT) transmission session.

In one embodiment of the present invention, the session is a Transmission Control Protocol or Wireless Transmission Protocol session. A SYN bit (SYN bit on) of a TCP message can be used as a predetermined identifier for triggering the resource reservation.

The system of the present invention comprises means for determining one or more identifiers to be tracked included in one or more setup messages of a session, means for detecting the identifier(s) within one or more setup messages of the session; and means for reserving part or all of the transport resources needed for the data transmission between the sender node and receiver node beforehand in response to detecting the identifier(s) within one or more setup messages of the session with means for detecting.

In one embodiment of the present invention, the system further comprises a timer for measuring time after detecting the predetermined identifier(s) within one or more setup messages of the session with means for detecting. Means for reserving are arranged to reserve part or all of the transport resources needed for the data transmission between the sender node and receiver node beforehand in response to detecting the identifier(s) within one or more setup messages of the session with means for detecting when the timer expires.

In one embodiment of the present invention, means for detecting are arranged to choose an appropriate TCP session setup message with the SYN bit on for the reservation of resources.

In one embodiment of the present invention, means for detecting the identifier(s) within one or more setup messages of the session are arranged in the Packet Data Convergence Protocol (PDCP) layer of the Radio Network Controller (RNC) of the UTRAN.

The present invention has several advantages over the prior-art solutions. The setup delays for the resources needed for data transmission sessions are decreased. This decreases the delay a user experiences, which can also be expressed as an increase in the experienced bit rate.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a prior-art signaling flow diagram for the setup of a TCP session when HyperText Transfer Protocol (HTTP) is used,

FIG. 2 is a signaling flow diagram for the setup of a TCP session when HyperText Transfer Protocol (HTTP) is used in accordance with the present invention,

FIG. 3 is a comparison of the user experienced delay between the standard session based data connection without resource prediction and session based data connection with resource prediction, and

FIG. 4 illustrates an embodiment of a system in accordance with the present invention.

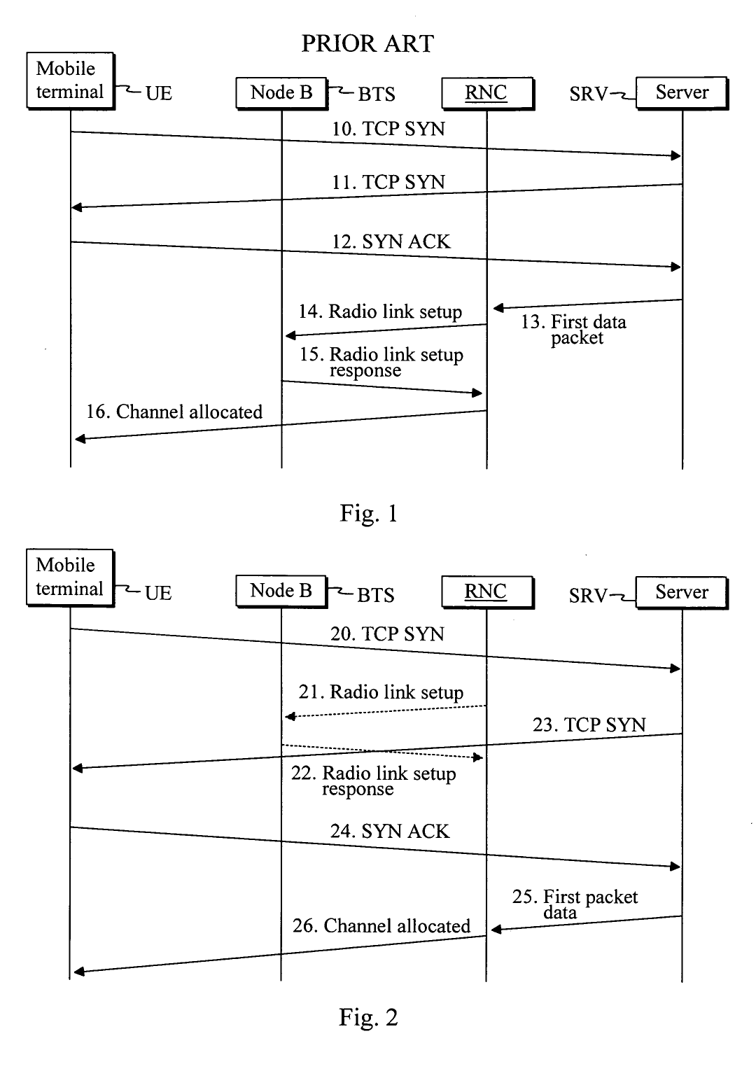

### DETAILED DESCRIPTION OF THE INVENTION

Reference will now be made in detail to the embodiments of the present invention, examples of which are illustrated in the accompanying drawings.

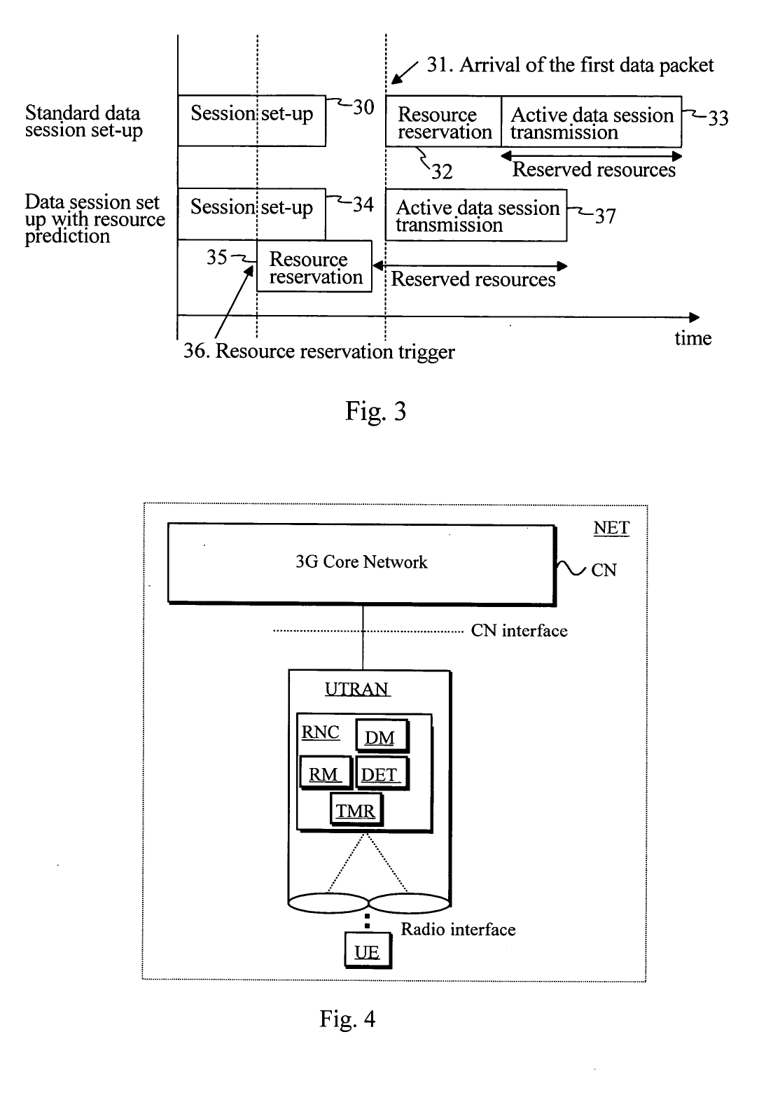

FIG. 2 describes a signalling flow for the setup of a TCP connection when the HTTP used. The SYN messages trigger the Iub resource setup. The Iub interface is an UTRAN specific interface between the RNC and BTS (or Node B). The Iub interface is described in more detail in the 3^{rd} Generation Partnership Project (3GPP) specifications 3GPP TS 25.425, 3GPP TS 25.426, 3GPP TS 25.427 and 3GPP TS 25.430-3GPP TS 25.435. In the preferred embodiment, the TCP session setup messages are read in the PDCP layer of the RNC. In the following, FIG. 2 will now be described in more detail.
20. The TCP SYN message. The synchronization of the requesting end's (mobile terminal UE) sequence number. This message has the SYN flag in the TCP header. The RNC notices that the SYN flag is on and starts the Iub resource setup.
21. The RNC has to setup the Iub resource. It sends a Node B Application part (NBAP) message to the Node B: Radio Link Setup.
22. The node B responds to the RNC: Radio Link Setup Response. There might be some signaling related to the Asynchronous Transfer Mode (ATM) links, e.g. ATM Adaptation Layer 2 (AAL2), but they are not represented in this picture. Also Radio Resource Control (RRC) messaging to the mobile terminal UE is not shown. FIG. 2 does not assume that the radio resources are reserved, or that a Dedicated Transport Channel (DCH) would be fully setup, which may also be performed.
23. The TCP SYN message. The synchronization of the server SRV end's sequence number. This message has the SYN flag on in the TCP header. The triggering of the Iub setup procedure point may be set to this second SYN message, or to the fact that this is the SYN in down link direction (usually it is the mobile terminal UE end that requests the service, and therefore, the setup the TCP).
24. The mobile terminal UE acknowledges the server's SYN. This is a normal acknowledgement message. A possible HTTP request can be sent to server within this message. It is also possible to read the actual user data, and notice that this is the HTTP request, and trigger the Iub setup.
25. The server SRV responds to the HTTP request by starting the data transmission and sends the first packet. The packet arrives at the RNC, which notices that a dedicated channel should be allocated (or if the whole DCH allocation is performed after the triggering, it is already there). The Iub resource has anyhow already been allocated.
26. A dedicated channel is allocated and the data packet is transmitted to mobile terminal UE. The time between the first data packet arriving at the RNC and when it leaves the RNC is smaller than with the traditional method (the comparison is described in more detail in FIG. 3). The user of the mobile terminal UE experiences this as better service and better bit rate.

As described above, the RRC messaging to the mobile terminal UE is not shown. In any case, the radio resources may or may not be reserved at the same time. It is still possible to perform the actual signaling for the channel switching in the radio interface as nowadays when the first data packets arrive. In FIG. 2, the radio resources are not reserved, but only the Iub resources. In many communication networks comprising wireless resources, radio resources cannot be wasted. Therefore, the radio resources are reserved only after there is data to be sent to the mobile terminal.

In one embodiment of FIG. 2, timer functionality is used when reserving resources. When a TCP SYN message is detected, a timer is started. With the timer it is possible to adjust the actual moment the resources are reserved. When the timer expires, part or all of the resources needed for the data transmission are reserved.

FIG. 3 describes a comparison of the user experienced delay between the standard session based data connection without resource prediction and session based data connection with resource prediction. FIG. 3 represents the different phases of a data session as a function of time. It shows how the delay penalty incurred by the reservation of resources can be avoided by triggering the resource reservation during the session setup phase.

The upper part of FIG. 3 describes the standard data session setup. At first, the session is setup in a normal way (30). When the first data packet arrives (31), resources are reserved (32). When the resource reservation is finished, the active data session transmission can start (33). The structure of the resource reservation process is sequential.

The lower part of FIG. 3 describes the resource reservation method in accordance with the present invention. The session is setup as in the standard solution (34). However, the next phase is different than in the standard solution. The session setup (34) comprises e.g. a TCP SYN message as described in FIG. 2. The TCP SYN message triggers the resource reservation (35, 36). When the first data packet arrives (31), the resources are already reserved and active data session transmission can start (37). The structure of the resource reservation process differs from the standard solution. The structure is now parallel.

The same method of reserving resources can be used for other transport connection setup messages, such as WTP session setup or invoke messages. It is usually the user (mobile terminal) that sets up the TCP or WTP connection at the transport protocol level, and therefore, the functionality may not be needed in both uplink and downlink traffic directions.

FIG. 4 represents an exemplary embodiment of the system in which the present invention can be used. The architecture of FIG. 4 comprises a communication network NET comprising the UTRAN radio access network. The radio access network UTRAN is connected to the core network CN. The UTRAN comprises a Radio Network Controller RNC controlling the radio access network UTRAN. The mobile terminal UE is connected to the radio access network UTRAN via the radio interface. It must be noted that FIG. 4 comprises only some of the components present in a real network.

The RNC comprises means for determining DM one or more identifiers to be tracked included in one or more setup messages of the session, means for detecting DET the identifier(s) within one or more setup messages of the session, and means for reserving RM part or all of the transport resources needed for the data transmission between the sender node UE and receiver node beforehand in response to detecting the identifier(s) within one or more setup messages of the session with means for detecting DET. The RNC comprises also a timer TMR for measuring the time after detecting the identifier(s) within one or more setup messages of the session with means for detecting DET. When the timer TMR is used, means for reserving RM are arranged to reserve part or all of the transport resources needed for the data transmission between the sender node UE and receiver node beforehand in response to detecting the identifier(s) within one or more setup messages of the session with means for detecting DET when the timer expires. The above-mentioned means are in a preferred embodiment implemented with hardware and/or software components.

The total amount of time during which the resources are kept under reservation can be optimized by choosing the right trigger to start the reservation. This avoids reserving the resources too much in advance before they are actually going to be used, which could mean degradations in the system capacity. The right trigger can be defined by:
selecting the appropriate TCP session setup message out of the three ones involved in the handshake, and/or
using of a timer TMR to adjust the exact start of the reservation after the corresponding TCP trigger has occurred.

In one embodiment of FIG. 4, one or more of the aforementioned means are implemented in the PDCP layer of the RNC of the UTRAN. The PDCP layer in UTRAN is used, for example, to compress different kinds of headers. It is possible to implement in the PDCP, or near it, a function that reads the TCP headers of the messages and recognizes the session setup messages (if the SYN bit is on). The Iub setup can then be performed beforehand. The PDCP is specified, e.g. in the 3GPP TS 25 323 V5.1.0 (2002-06).

In general, the present invention can be used in any other mobile or wireline network if there exists some resources that should be reserved and the reservation takes time. The solution for reserving resources described in the present invention can be used to trigger resource reservation and/or setup of a resource if the transport protocol session setup messages can be distinguished from other messages. In the preferred embodiment of the present invention, the need of resources is predicted by monitoring the TCP packets. The session level setup messages indicate the forthcoming arrival of data and trigger the resource reservation.

It is obvious to a person skilled in the art that with the advancement of technology, the basic idea of the invention may be implemented in various ways. The invention and its embodiments are thus not limited to the examples described above, instead they may vary within the scope of the claims.

1. A method for reserving transport resources in a communication network, wherein transport resources have to be reserved for data transmissions, wherein the method comprises the steps of:
setting up a session for a data transmission between a sender node and receiver node;
reserving necessary transmission resources for the data transmission;
transmitting data within said session between the sender node and receiver node;
characterized in that the method further comprises the steps of:
determining one or more identifiers to be tracked included in one or more setup messages of said session;
detecting said identifier(s) within one or more setup messages of said session; and in response to detecting said identifier(s),
reserving part or all of the transport resources needed for the data transmission between said sender node and receiver node beforehand.

2. The method according to claim 1, characterized in that when detecting said identifier(s) used in one or more setup messages of said session, the method comprises the steps of:
starting a timer; and
reserving part or all of the resources needed for the data transmission when said timer expires.

3. The method according to claim 1, characterized in that said reservation of transport resources comprises reservation of radio and/or wireline resources.

4. The method according to claim 1, characterized in that said session is a non real-time data transmission session.

5. The method according to claim 1, characterized in that said session is a Transmission Control Protocol or Wireless Transmission Protocol session.

6. The method according to claim 5, characterized in that said transport protocol session setup message is a TCP message with the SYN bit on.

7. The method according to claim 6, characterized in that the method further comprises the step of:
choosing an appropriate TCP session setup message with said SYN bit on for said reservation of resources.

8. The method according to claim 1, characterized in that said communication network comprises the UTRAN, IP-RAN, GERAN, CDMA2000 or WLAN.

9. A system for reserving transport resources in a communication network, wherein transport resources have to be reserved for data transmissions, wherein the system comprises:
a communication network (NET);
a plurality of nodes (UE, BTS, SRV, RNC) in said communication network (NET), said nodes (UE, BTS, SRV, RNC) comprising at least a sender node (UE) and receiver node (SRV), said nodes (UE, BTS, SRV, RNC) being connected to one or more other nodes (UE, BTS, SRV, RNC) within said communication network (NET);
characterized in that the system further comprises:
means for determining (DM) one or more identifiers to be tracked included in one or more setup messages of said session;
means for detecting (DET) said identifier(s) within one or more setup messages of said session; and
means for reserving (RM) part or all of the transport resources needed for the data transmission between said sender node (UE) and receiver node (SRV) beforehand in response to detecting said identifier(s) within one or more setup messages of said session with means for detecting (DET).

10. The system according to claim 9, characterized in that the system further comprises:
a timer (TMR) for measuring time after detecting said identifier(s) within one or more setup messages of said session with means for detecting (DET); and
means for reserving (RM) arranged to reserve part or all of the transport resources needed for the data transmission between said sender node (UE) and receiver node (SRV) beforehand in response to detecting said identifier(s) within one or more setup messages of said session with means for detecting (DET) when said timer (TMR) expires.

11. The system according to claim 9, characterized in that said transport resources comprise radio and/or wireline resources.

12. The system according to claim 9, characterized in that said session is a non real-time data transmission session.

13. The system according to claim 9, characterized in that said session is a Transmission Control Protocol or Wireless Transmission Protocol session.

14. The system according to claim 13, characterized in that said transport protocol session setup message is a TCP message with the SYN bit on.

15. The system according to claim 9, characterized in that means for detecting (DET) are arranged to choose an appropriate TCP session setup message with said SYN bit on for said reservation of resources.

16. The system according to claim 9, characterized in that said communication network (NET) comprises the UTRAN, IP-RAN, GERAN, CDMA2000 or WLAN.

17. The system according to claim 9, characterized in that means for detecting (DET) said identifier(s) within one or more setup messages of said session are arranged in the PDCP layer of the RNC of the UTRAN.
